(19) United States
(12) Patent Application Publication
(10) Pub. No.: US 2026/0279292 A1
(43) Pub. Date: Sep. 17, 2026

(54) DISPLAY DEVICE AND ELECTRONIC DEVICE

(71) Applicant: Samsung Display Co., Ltd., Yongin-si (KR)

(72) Inventors: Jin Seon KWAK, Yongin-si (KR); Jang Mi KANG, Yongin-si (KR); Keon Min OH, Yongin-si (KR); Yun Jang PYUN, Yongin-si (KR)

(21) Appl. No.: 19/545,478

(22) Filed: Feb. 20, 2026

(30) Foreign Application Priority Data
Mar. 11, 2025 (KR) 10-2025-0031187

(51) Int. Cl. G09G 3/3291

(52) U.S. Cl. CPC G09G 3/3291; G09G 2310/027; G09G 2310/0291; G09G 2320/0276; G09G 2320/0673

(57) ABSTRACT

A display device includes: a first data driving circuit on one side of a display area; a first distribution circuit between the first data driving circuit and the display area; and a gamma circuit generating a plurality of grayscale voltages, the first data driving circuit including a first data processing circuit, and a first data output circuit converting first digital image data into a first analog image signal and providing the converted first analog image signal to the first distribution circuit, the first data output circuit is between the first data processing circuit and the first distribution circuit, the gamma circuit including a master gamma circuit generating a gamma reference voltage based, and a first slave gamma circuit generating a plurality of grayscale voltages by dividing the gamma reference voltage, and the first slave gamma circuit is between the first data processing circuit and the first data output circuit.

### CROSS-REFERENCE TO RELATED APPLICATION

The present application claims priority to and the benefit of Korean Patent Application No. 10-2025-0031187, filed on Mar. 11, 2025, in the Korean Intellectual Property Office, the entire disclosure of which is incorporated herein by reference.

### BACKGROUND

### 1. Field

Aspects of some embodiments of the present disclosure relate to a display device and an electronic device including the same.

### 2. Description of the Related Art

Organic light emitting diode displays have self-light emitting characteristics, and may have relatively reduced thickness and weight because of not requiring a separate light source unlike the liquid crystal display. In addition, organic light emitting diode displays are attracting attention as the next-generation display device for TVs, monitors, and portable electronic devices, because exhibiting high-quality characteristics such as relatively low power consumption, high luminance, and high response speed.

The above information disclosed in this Background section is only for enhancement of understanding of the background and therefore the information discussed in this Background section does not necessarily constitute prior art.

### SUMMARY

Aspects of some embodiments of the present disclosure relate to a display device and an electronic device including the same, and for example, to a display device and an electronic device in which outputs from a data output circuit may be stably supplied to a distribution circuit, and in which a length of the data output circuit may be relatively reduced.

Aspects of some embodiments of the present disclosure include a display device and an electronic device in which outputs from a data output circuit may be stably supplied to a distribution circuit, and in which a length of the data output circuit may be relatively reduced.

According to some embodiments of the present disclosure, a display device includes: a display panel including a display area and a non-display area; a first data driving circuit in a non-display area on one side of the display area; a first distribution circuit in a non-display area between the first data driving circuit and the display area; and a gamma circuit generating a plurality of grayscale voltages, wherein the first data driving circuit includes a first data processing circuit processing first digital image data, and a first data output circuit converting the first digital image data from the first data processing circuit into a first analog image signal based on the plurality of grayscale voltages from the gamma circuit and providing the converted first analog image signal to the first distribution circuit, the first data output circuit is in a non-display area between the first data processing circuit and the first distribution circuit, the gamma circuit includes a master gamma circuit generating a gamma reference voltage based on a reference voltage and generating a plurality of grayscale voltages by dividing the gamma reference voltage, and a first slave gamma circuit generating a plurality of grayscale voltages by dividing the gamma reference voltage from the master gamma circuit, and the first slave gamma circuit is in a non-display area between the first data processing circuit and the first data output circuit.

According to some embodiments of the present disclosure, an electronic device includes a display device including a display screen, wherein the display device includes: a display panel including a display area and a non-display area; a first data driving circuit in a non-display area on one side of the display area; a first distribution circuit in a non-display area between the first data driving circuit and the display area; and a gamma circuit generating a plurality of grayscale voltages, the first data driving circuit includes a first data processing circuit processing first digital image data, and a first data output circuit converting the first digital image data from the first data processing circuit into a first analog image signal based on the plurality of grayscale voltages from the gamma circuit and providing the converted first analog image signal to the first distribution circuit, the first data output circuit is in a non-display area between the first data processing circuit and the first distribution circuit, the gamma circuit includes a master gamma circuit generating a gamma reference voltage based on a reference voltage and generating a plurality of grayscale voltages by dividing the gamma reference voltage, and a first slave gamma circuit generating a plurality of grayscale voltages by dividing the gamma reference voltage from the master gamma circuit, and the first slave gamma circuit is in a non-display area between the first data processing circuit and the first data output circuit.

In a display device and an electronic device including the same according to some embodiments, the outputs from the data output circuit may be relatively stably supplied to the distribution circuit and the length of the data output circuit may be relatively reduced.

For example, according to some embodiments, because the slave gamma circuits are not located between the circuit blocks of the data output circuit, but are located each adjacent to the edges on both sides of the data output circuit, the output terminals of the data output circuit and the input terminals of the distribution circuit may be connected without separate fan-out lines. Therefore, the outputs from the data output circuit may be relatively stably supplied to the distribution circuit.

Further, because the slave gamma circuits are not located between the circuit blocks of the data output circuit, but are located each adjacent to the edges on both sides of the data output circuit, the length of the data output circuit may be relatively reduced. Therefore, an exposure may be possible in one shot during the photolithography process for forming the data output circuit.

The characteristics of embodiments according to the present disclosure are not limited to the above-described characteristics and other characteristics which are not described herein will become more apparent to those skilled in the art from the following description.

### BRIEF DESCRIPTION OF THE DRAWINGS

The above and other aspects and features of embodiments according to the present disclosure will become more apparent by describing in more detail aspects of some embodiments thereof with reference to the attached drawings, in which:

FIG. 1 is an exploded perspective view illustrating a display device according to some embodiments;

FIG. 2 is a block diagram illustrating the display device according to some embodiments;

FIG. 3 is an equivalent circuit diagram of a first sub-pixel according to some embodiments;

FIG. 4 is a layout view illustrating an example of a display panel according to some embodiments;

FIG. 5 is a detailed configuration diagram of a first data driving circuit of FIG. 4;

FIG. 6 is a block diagram of an electronic device according to some embodiments; and

FIGS. 7, 8, and 9 are schematic diagrams of electronic devices according to some embodiments.

### DETAILED DESCRIPTION

Aspects of some embodiments of the present disclosure will now be described more fully hereinafter with reference to the accompanying drawings, in which aspects of some embodiments of the present disclosure are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

It will also be understood that when a layer is referred to as being “on” another layer or substrate, it can be directly on the other layer or substrate, or intervening layers may also be present. The same reference numbers indicate the same components throughout the specification. In the attached figures, the thickness of layers and regions is exaggerated for clarity.

Although the terms “first”, “second”, etc. may be used herein to describe various elements, these elements, should not be limited by these terms. These terms may be used to distinguish one element from another element. Thus, a first element discussed below may be termed a second element without departing from teachings of one or more embodiments. The description of an element as a “first” element may not require or imply the presence of a second element or other elements. The terms “first”, “second”, etc. may also be used herein to differentiate different categories or sets of elements. For conciseness, the terms “first”, “second”, etc. may represent “first-category (or first-set)”, “second-category (or second-set)”, etc., respectively.

Features of various embodiments of the present disclosure may be combined partially or totally. As will be clearly appreciated by those skilled in the art, technically various interactions and operations are possible. Various embodiments can be practiced individually or in combination.

Hereinafter, aspects of some embodiments will be described in more detail with reference to the accompanying drawings.

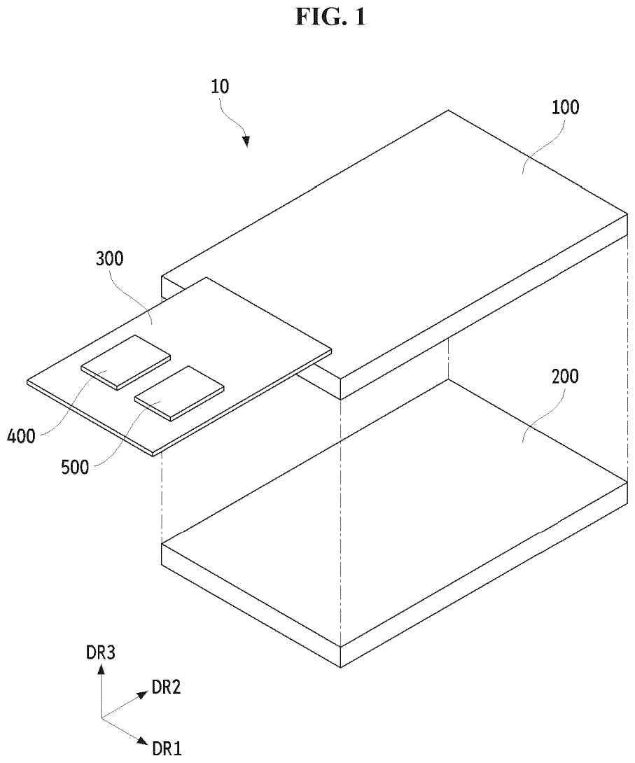

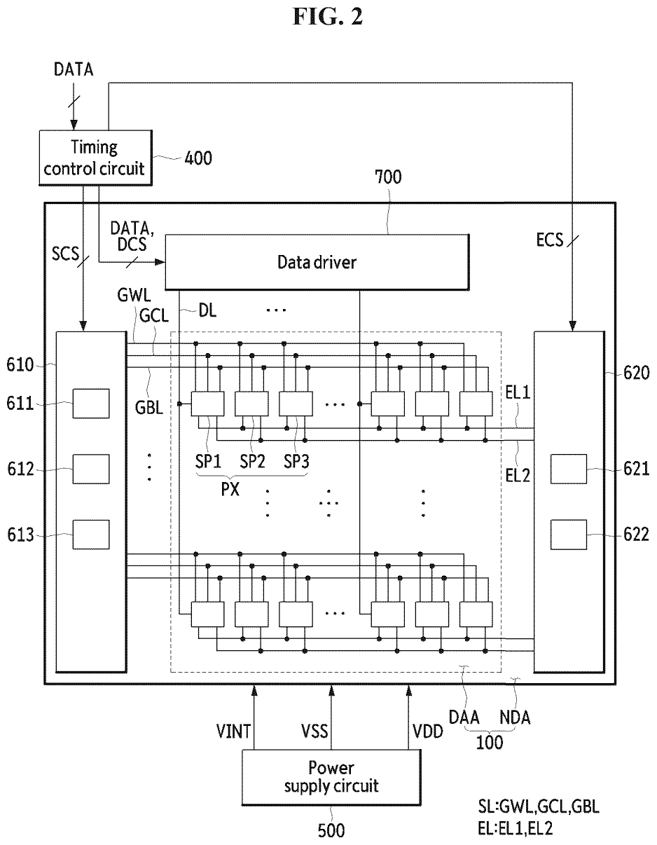

FIG. 1 is an exploded perspective view illustrating a display device according to some embodiments. FIG. 2 is a block diagram illustrating the display device according to some embodiments.

Referring to FIGS. 1 and 2, a display device 10 according to some embodiments is a device capable of displaying moving images (e.g., video images) or still images (e.g., static images). The display device 10 according to some embodiments may be applied to portable electronic devices such as a mobile phone, a smart phone, a tablet personal computer (PC), a mobile communication terminal, an electronic notebook, an electronic book, a portable multimedia player (PMP), navigation, and an ultra mobile PC (UMPC). For example, the display device 10 according to some embodiments may be applied to a display unit of a television, a laptop computer, a monitor, a billboard, or the Internet of Things (IoT). Alternatively, the display device 10 according to some embodiments may be applied to a smart watch, a watch phone, and a head mounted display (HMD) for implementing virtual reality and augmented reality.

The display device 10 according to some embodiments includes a display panel 100, a heat dissipation layer 200, a circuit board 300, a timing control circuit 400, and a power supply circuit 500.

The display panel 100 may be formed in a planar shape similar to a quadrangle. For example, the display panel 100 may have a planar shape similar to a quadrangle having short sides in a first direction DR1 and long sides in a second direction DR2 intersecting the first direction DR1. In the display panel 100, a corner where the short side in the first direction DR1 and the long side in the second direction DR2 meet may be rounded to have a curvature or may be formed at a right angle. The planar shape of the display panel 100 is not limited to the quadrangle, and may be formed similarly to other polygons, circles, or ovals, or may have an irregular shape in a plan view. A planar shape of the display device 10 may follow the planar shape of the display panel 100, but the embodiments of the present disclosure are not limited thereto.

The display panel 100 includes a plurality of pixels PX, a plurality of scan lines SL, a plurality of emission control lines EL, a plurality of data lines DL, a scan driver 610, a light emitting driver 620, and a data driver 800. The display panel 100 may be divided into a display area DAA displaying images and a non-display area NDA that does not display images, as illustrated in FIG. 2.

The plurality of pixels PX may be located in the display area DAA. The plurality of pixels PX may be arranged in a matrix form or arrangement (e.g., in a plurality of columns and rows) in the first direction DR1 and the second direction DR2. The plurality of scan lines SL and the plurality of emission control lines EL may extend in the first direction DR1 and may be located in the second direction DR2. The plurality of data lines DL may extend in the second direction DR2 and may be arranged in the first direction DR1.

The plurality of scan lines SL includes a plurality of write scan lines GWL, a plurality of control scan lines GCL, and a plurality of bias scan lines GBL. The plurality of emission control lines EL include a plurality of first emission control lines EL1 and a plurality of second emission control lines EL2.

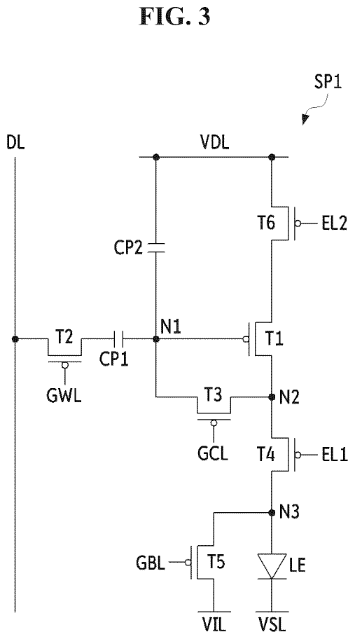

The plurality of pixels PX include a plurality of sub-pixels SP1, SP2, and SP3. The plurality of sub-pixels SP1, SP2, and SP3 may include a plurality of pixel transistors as illustrated in FIG. 3, and the plurality of pixel transistors may be formed through a semiconductor process and may be located on a semiconductor substrate. For example, the plurality of pixel transistors of the data driver 800 may be formed of a Complementary Metal Oxide Semiconductor (CMOS), but the embodiments of the present disclosure are not limited thereto.

Each of the plurality of sub-pixels SP1, SP2, and SP3 may be connected to any one write scan line GWL among the plurality of write scan lines GWL, any one control scan line GCL among the plurality of control scan lines GCL, any one bias scan line GBL among the plurality of bias scan lines GBL, any one first emission control line EL1 among the plurality of first emission control lines EL1, any one second emission control line EL2 among the plurality of second emission control lines EL2, and any one data line DL among the plurality of data lines DL. Each of the plurality of sub-pixels SP1, SP2, and SP3 may receive a data voltage of the data line DL according to a write scan signal of the write scan line GWL, and may emit light from a light emitting element according to the data voltage.

The scan driver 610, the light emitting driver 620, and the data driver 800 may be located in the non-display area NDA.

The scan driver 610 includes a plurality of scan transistors, and the light emitting driver 620 includes a plurality of light emitting transistors. The plurality of scan transistors and the plurality of light emitting transistors may be formed through a semiconductor process and may be formed on a semiconductor substrate. For example, the plurality of scan transistors and the plurality of light emitting transistors may be formed of CMOS, but the embodiments of the present disclosure are not limited thereto.

The scan driver 610 may include a write scan signal output unit 611, a control scan signal output unit 612, and a bias scan signal output unit 613. Each of the write scan signal output unit 611, the control scan signal output unit 612, and the bias scan signal output unit 613 may receive a scan timing control signal SCS from the timing control circuit 400. The write scan signal output unit 611 may generate write scan signals according to the scan timing control signal SCS of the timing control circuit 400 and sequentially output the write scan signals to the write scan lines GWL. The control scan signal output unit 612 may generate control scan signals according to the scan timing control signal SCS and sequentially output the control scan signals to the control scan lines GCL. The bias scan signal output unit 613 may generate bias scan signals according to the scan timing control signal SCS and sequentially output the bias scan signals to the bias scan lines GBL.

The light emitting driver 620 includes a first emission control driver 621 and a second emission control driver 622. Each of the first emission control driver 621 and the second emission control driver 622 may receive an emission timing control signal ECS from the timing control circuit 400. The first emission control driver 621 may generate first emission control signals according to the emission timing control signal ECS and sequentially output the first emission control signals to the first emission control lines EL1. The second emission control driver 622 may generate second emission control signals according to the emission timing control signal ECS and sequentially output the second emission control signals to the second emission control lines EL2.

The data driver 800 may include a plurality of data transistors, and the plurality of data transistors may be formed through a semiconductor process and may be formed on a semiconductor substrate. For example, the plurality of data transistors may be formed of CMOS, but the embodiments of the present disclosure are not limited thereto.

The data driver 800 may receive digital video data DATA and a data timing control signal DCS from the timing control circuit 400. The data driver 800 converts the digital video data DATA into analog data voltages according to the data timing control signal DCS and outputs the converted analog data voltages to the data lines DL. In this case, the sub-pixels SP1, SP2, and SP3 may be selected by the write scan signals of the scan driver 610, and the data voltages may be supplied to the selected sub-pixels SP1, SP2, and SP3.

The heat dissipation layer 200 may overlap the display panel 100 in a third direction DR3, which is a thickness direction of the display panel 100. The heat dissipation layer 200 may be located on one surface of the display panel 100, for example, a rear surface of the display panel 100. The heat dissipation layer 200 serves to dissipate heat generated from the display panel 100. The heat dissipation layer 200 may include a metal layer such as graphite, silver (Ag), copper (Cu), or aluminum (Al) having high thermal conductivity.

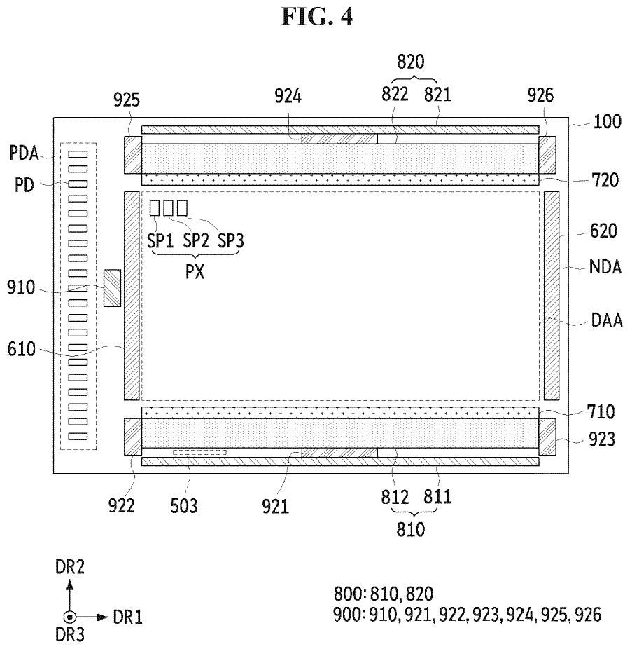

The circuit board 300 may be electrically connected to a plurality of pads (PD in FIG. 4) of a pad portion (PDA in FIG. 4) of the display panel 100 by using a conductive adhesive member such as an anisotropic conductive film. The circuit board 300 may be a flexible printed circuit board or flexible film made of a flexible material. It is illustrated in FIG. 1 that the circuit board 300 is unfolded, but the circuit board 300 may be bent. In this case, one end of the circuit board 300 may be located on the rear surface of the display panel 100 and/or a rear surface of the heat dissipation layer 200. The other end of the circuit board 300 may be connected to a plurality of pads (PD in FIG. 4) of a pad portion (PDA in FIG. 4) of the display panel 100 by using a conductive adhesive member. One end of the circuit board 300 may be an end opposite to the other end of the circuit board 300.

The timing control circuit 400 may receive digital video data and timing signals from the outside. The timing control circuit 400 may generate a scan timing control signal SCS, an emission timing control signal ECS, and a data timing control signal DCS for controlling the display panel 100 according to the timing signals. The timing control circuit 400 may output the scan timing control signal SCS to the scan driver 610 and output the emission timing control signal ECS to the light emitting driver 620. The timing control circuit 400 may output the digital video data and the data timing control signal DCS to the data driver 800.

The power supply circuit 500 may generate a plurality of panel driving voltages according to a power voltage from the outside. For example, the power supply circuit 500 may generate a first driving voltage VSS, a second driving voltage VDD, and a third driving voltage VINT and supply the generated driving voltages to the display panel 100. The first driving voltage VSS, the second driving voltage VDD, and the third driving voltage VINT will be described in more detail below with reference to FIG. 3.

Each of the timing control circuit 400 and the power supply circuit 500 may be formed as an integrated circuit (IC) and attached to one surface of the circuit board 300. In this case, the scan timing control signal SCS, the emission timing control signal ECS, the digital video data DATA, and the data timing control signal DCS of the timing control circuit 400 may be supplied to the display panel 100 through the circuit board 300. In addition, the first driving voltage VSS, the second driving voltage VDD, and the third driving voltage VINT of the power supply circuit 500 may be supplied to the display panel 100 through the circuit board 300.

Alternatively, each of the timing control circuit 400 and the power supply circuit 500 may be located in the non-display area NDA of the display panel 100, similarly to the scan driver 610, the light emitting driver 620, and the data driver 800. In this case, the timing control circuit 400 may include a plurality of timing transistors, and each power supply circuit 500 may include a plurality of power transistors. The plurality of timing transistors and the plurality of power transistors may be formed through a semiconductor process and may be formed on a semiconductor substrate. For example, the plurality of timing transistors and the plurality of power transistors may be formed of CMOS, but the embodiments of the present disclosure are not limited thereto. Each of the timing control circuit 400 and the power supply circuit 500 may be located between the data driver 800 and the pad portion (PDA in FIG. 4).

FIG. 3 is an equivalent circuit diagram of a first sub-pixel according to some embodiments. Although FIG. 3 illustrates various components in a circuit diagram of a sub-pixel according to some embodiments, embodiments according to the present disclosure are not limited thereto, and according to various embodiments, the circuit may include additional components, or fewer components, without departing from the spirit and scope of embodiments according to the present disclosure.

Referring to FIG. 3, the first sub-pixel SP1 may be connected to the write scan line GWL, the control scan line GCL, the bias scan line EBL, the first emission control line EL1, the second emission control line EL2, and the data line DL. In addition, the first sub-pixel SP1 may be connected to a first driving voltage line VSL to which the first driving voltage VSS corresponding to a low potential voltage is applied, a second driving voltage line VDL to which the second driving voltage VDD corresponding to a high potential voltage is applied, and a third driving voltage line VIL to which the third driving voltage VINT corresponding to an initialization voltage is applied. That is, the first driving voltage line VSL may be a low potential voltage line, the second driving voltage line VDL may be a high potential voltage line, and the third driving voltage line VIL may be an initialization voltage line. In this case, the first driving voltage VSS may be a voltage lower than the third driving voltage VINT. The second driving voltage VDD may be a voltage higher than the third driving voltage VINT.

The first sub-pixel SP1 includes a plurality of transistors T1 to T6, a light emitting element LE, a first capacitor CP1, and a second capacitor CP2.

The light emitting element LE emits light according to a driving current Ids flowing through a channel of a first transistor T1. An amount of light emitted from the light emitting element LE may be proportional to the driving current Ids. The light emitting element LE may be located between a fourth transistor T4 and the first driving voltage line VSL. A first electrode of the light emitting element LE may be connected to a drain electrode of the fourth transistor T4, and a second electrode thereof may be connected to the first driving voltage line VSL. The first electrode of the light emitting element LE may be an anode electrode, and the second electrode of the light emitting element LE may be a cathode electrode. The light emitting element LE may be an organic light emitting diode including a first electrode, a second electrode, and an organic light emitting layer located between the first electrode and the second electrode, but the embodiments of the present disclosure are not limited thereto. For example, the light emitting element LE may be an inorganic light emitting element including a first electrode, a second electrode, and an inorganic semiconductor located between the first electrode and the second electrode. In this case, the light emitting element LE may be a micro light emitting diode.

The first transistor T1 may be a driving transistor that controls a source-drain current Ids (hereinafter, referred to as “driving current”) flowing between a source electrode and a drain electrode according to a voltage applied to a gate electrode. The first transistor T1 includes a gate electrode connected to a first node N1, a source electrode connected to a drain electrode of a sixth transistor T6, and a drain electrode connected to a second node N2.

A second transistor T2 may be located between one electrode of the first capacitor CP1 and the data line DL. The second transistor T2 is turned on by the write scan signal of the write scan line GWL and connects one electrode of the first capacitor CP1 to the data line DL. Accordingly, the data voltage of the data line DL may be applied to one electrode of the first capacitor CP1. The second transistor T2 includes a gate electrode connected to the write scan line GWL, a source electrode connected to the data line DL, and a drain electrode connected to one electrode of the first capacitor CP1.

A third transistor T3 may be located between the first node N1 and the second node N2. The third transistor T3 is turned on by the write control signal of the write control line GCL and connects the first node N1 to the second node N2. Accordingly, when the gate electrode and the source electrode of the first transistor T1 are connected, the first transistor T1 may operate like a diode. The third transistor T3 includes a gate electrode connected to the write control line GCL, a source electrode connected to the second node N2, and a drain electrode connected to the first node N1.

A fourth transistor T4 may be connected between the second node N2 and a third node N3. The fourth transistor T4 is turned on by the first emission control signal of the first emission control line EL1 and connects the second node N2 to the third node N3. Accordingly, the driving current of the first transistor T1 may be supplied to the light emitting element LE. The fourth transistor T4 includes a gate electrode connected to the first emission control line EL1, a source electrode connected to the second node N2, and a drain electrode connected to the third node N3.

A fifth transistor T5 may be located between the third node N3 and the third driving voltage line VIL. The fifth transistor T5 is turned on by the bias scan signal of the bias scan line EBL and connects the third node N3 to the third driving voltage line VIL. Accordingly, the third driving voltage VINT of the third driving voltage line VIL may be applied to the first electrode of the light emitting element LE. The fifth transistor T5 includes a gate electrode connected to the bias scan line EBL, a source electrode connected to the third node N3, and a drain electrode connected to the third driving voltage line VIL.

A sixth transistor T6 may be located between the source electrode of the first transistor T1 and the second driving voltage line VDL. The sixth transistor T6 is turned on by the second emission control signal of the second emission control line EL2 and connects the source electrode of the first transistor T1 to the second driving voltage line VDL. Accordingly, the second driving voltage VDD of the second driving voltage line VDL may be applied to the source electrode of the first transistor T1. The sixth transistor T6 includes a gate electrode connected to the second emission control line EL2, a source electrode connected to the second driving voltage line VDL, and a drain electrode connected to the source electrode of the first transistor T1.

The first capacitor CP1 is formed between the first node N1 and the drain electrode of the second transistor T2. The first capacitor CP1 includes one electrode connected to the drain electrode of the second transistor T2 and the other electrode connected to the first node N1.

The second capacitor CP2 is formed between the gate electrode of the first transistor T1 and the second driving voltage line VDL. The second capacitor CP2 includes one electrode connected to the gate electrode of the first transistor T1 and the other electrode connected to the second driving voltage line VDL.

The first node N1 is a contact point of the gate electrode of the first transistor T1, the drain electrode of the third transistor T3, the other electrode of the first capacitor CP1, and one electrode of the second capacitor CP2. The second node N2 is a contact point of the drain electrode of the first transistor T1, the source electrode of the third transistor T3, and the source electrode of the fourth transistor T4. The third node N3 is a contact point of the drain electrode of the fourth transistor T4, the source electrode of the fifth transistor T5, and the first electrode of the light emitting element LE.

Each of the first to sixth transistors T1 to T6 may be a metal-oxide-semiconductor field effect transistor (MOSFET). For example, each of the first to sixth transistors T1 to T6 may be a P-type MOSFET, but the embodiments of the present disclosure are not limited thereto. Each of the first to sixth transistors T1 to T6 may be an N-type MOSFET. Alternatively, each of some of the first to sixth transistors T1 to T6 may be a P-type MOSFET, and each of the remaining transistors may be an N-type MOSFET.

It is illustrated in FIG. 3 that the first sub-pixel SP1 includes the six transistors T1 to T6 and the two capacitors CP1 and CP2, but the equivalent circuit diagram of the first sub-pixel SP1 is not limited to that illustrated in FIG. 3.

In addition, an equivalent circuit diagram of a second sub-pixel SP2 and an equivalent circuit diagram of a third sub-pixel SP3 may be substantially the same as the equivalent circuit diagram of the first sub-pixel SP1 described with reference to FIG. 3. Therefore, the descriptions of the equivalent circuit diagram of the second sub-pixel SP2 and the equivalent circuit diagram of the third sub-pixel SP3 are omitted in the present specification.

FIG. 4 is a layout view illustrating an example of a display panel according to some embodiments.

Referring to FIG. 4, the display area DAA of the display panel 100 according to some embodiments includes a plurality of pixels PX arranged in a matrix form. The pixel PX may include a first sub-pixel SP1, a second sub-pixel SP2, and a third sub-pixel SP3 located adjacent to each other.

A scan driver 610, a light emitting driver 620, a data driver 800, a first distribution circuit 710, a second distribution circuit 720, a gamma circuit 900, and a pad portion PDA.

The scan driver 610 may be located on a first side of the display area DAA, and the light emitting driver 620 may be located on a second side of the display area DAA. For example, the scan driver 610 may be located on one side of the display area DAA in the first direction DR1, and the light emitting driver 620 may be located on the other side of the display area DAA in the first direction DR1. That is, the scan driver 610 may be located on a left side of the display area DAA, and the light emitting driver 620 may be located on a right side of the display area DAA. However, the embodiments of the present disclosure are not limited thereto, and the scan driver 610 and the light emitting driver 620 may be located on both the first side and the second side of the display area DAA.

The pad portion PDA may include a plurality of pads PD connected to pads or bumps of the circuit board 300 through a conductive adhesive member. The pad portion PDA may be located at the edge of the display panel adjacent to the scan driver 610.

The data driver 800 may include a first data driving circuit 810 and a second data driving circuit 820.

The first data driving circuit 810 may be located in a non-display area NDA on a third side (e.g., a lower side) of the display area DAA. For example, the first data driving circuit 810 may be located on one side of the display area DAA in the second direction DR2. The first data driving circuit 810 may include a first data processing circuit 811 and a first data output circuit 812.

The first data processing circuit 811 may process first digital image data signals from the timing control circuit 400 and provide the processed first digital image data signals to the first data output circuit 812.

The first data output circuit 812 may convert the first image data signals processed by the first data processing circuit 811 into analog and provide the converted signals to the first distribution circuit 710. For example, first analog image signals from the first data output circuit 812 may be provided to the first distribution circuit 710.

The second data driving circuit 820 may be located in a non-display area NDA on a fourth side (e.g., an upper side) of the display area DAA. For example, the second data driving circuit 820 may be located on the other side of the display area DAA in the second direction DR2. The second data driving circuit 820 may include a second data processing circuit 821 and a second data output circuit 822.

The second data processing circuit 821 may process second digital image data signals from the timing control circuit 400 and provide the processed second digital image data signals to the second data output circuit 822.

The second data output circuit 822 may convert the second image data signals processed by the second data processing circuit 821 into analog and provide the converted signals to the second distribution circuit 720. For example, second analog image signals from the second data output circuit 822 may be provided to the second distribution circuit 720.

The first distribution circuit 710 may be located in a non-display area NDA between the display area DAA and the first data driving circuit 810. For example, the first distribution circuit 710 may be located in a non-display area NDA between the display area DAA and the first data output circuit 812. The first distribution circuit 710 may divide the first analog image signals from the first data output circuit 812 in a time-division manner and provide the divided first analog image signals to a plurality of first data lines. For example, because the data lines DL may be divided into a plurality of first data lines and a plurality of second data lines, the first distribution circuit 710 may divide the first analog image signals in a time-division manner and provide the divided first analog image signals to the plurality of first data lines. The number of channels (e.g., output channels) of the first distribution circuit 710 may be equal to the number of first data lines, and the number of channels (e.g., output channels) of the first data output circuit 812 may be smaller than the number of channels (e.g., output channels) of the first distribution circuit 710. The first distribution circuit 710 may include, for example, a demultiplexer.

The second distribution circuit 720 may be located in a non-display area NDA between the display area DAA and the second data driving circuit 820. For example, the second distribution circuit 720 may be located in a non-display area NDA between the display area DAA and the second data output circuit 822. The second distribution circuit 720 may divide the second analog image signals from the second data output circuit 822 in a time-division manner and provide the divided second analog image signals to a plurality of second data lines. For example, the second distribution circuit 720 may divide the second analog image signals in a time-division manner and sequentially provide the divided second analog image signals to the plurality of second data lines. The number of channels (e.g., output channels) of the second distribution circuit 720 may be equal to the number of second data lines, and the number of channels (e.g., output channels) of the second data output circuit 822 may be smaller than the number of channels (e.g., output channels) of the second distribution circuit 720. The second distribution circuit 720 may include, for example, a demultiplexer.

The gamma circuit 900 may generate a plurality of grayscale voltages by dividing a gamma reference voltage, and provide the plurality of generated grayscale voltages (e.g., grayscale voltages of grayscale levels 0 to 255) to the data driver 800. For example, the gamma circuit 900 may provide the plurality of grayscale voltages to the first data output circuit 812 and the second data output circuit 822. The first data output circuit 812 may select a grayscale voltage corresponding to the first digital image data signal from the gamma circuit 900 and output the selected grayscale voltage as the first analog image signal. Similarly, the second data output circuit 822 may select a grayscale voltage corresponding to the second digital image data signal from the gamma circuit 900 and output the selected grayscale voltage as the second analog image signal. Here, the gamma circuit 900 may generate a plurality of red grayscale voltages for red image data, a plurality of green grayscale voltages for green image data, and a plurality of blue grayscale voltages for blue image data.

The gamma circuit 900 may include a master gamma circuit 910 and a plurality of slave gamma circuits 921, 922, 923, 924, 925, and 926.

The master gamma circuit 910 may generate a gamma reference voltage based on the reference voltage from the power supply circuit 500 and generate a plurality of grayscale voltages (e.g., grayscale voltages of grayscale levels 0 to 255) by dividing the generated gamma reference voltage. The grayscale voltages from the master gamma circuit 910 may be supplied to the first data output circuit 812 of the first data driving circuit 810 and the second data output circuit 822 of the second data driving circuit 820. In addition, the gamma reference voltage from the master gamma circuit 910 may be provided to the plurality of slave gamma circuits 921, 922, 923, 924, 925, and 926. The master gamma circuit 910 may be located in a non-display area NDA between the pad portion PDA and the scan driver 610. The master gamma circuit 910 may be connected to the power supply circuit 500 on the circuit board 300 through the pads PD of the pad portion PDA.

The plurality of slave gamma circuits 921, 922, 923, 924, 925, and 926 may include a first slave gamma circuit 921, a second slave gamma circuit 922, a third slave gamma circuit 923, a fourth slave gamma circuit 924, a fifth slave gamma circuit 925, and a sixth slave gamma circuit 926.

Each of the slave gamma circuits 921, 922, 923, 924, 925, and 926 may receive the gamma reference voltage from the master gamma circuit 910. Each of the slave gamma circuits 921, 922, 923, 924, 925, and 926 may generate a plurality of grayscale voltages (e.g., grayscale voltages of grayscale levels 0 to 255) by dividing the gamma reference voltage. For example, the first slave gamma circuit 921 may generate a plurality of grayscale voltages (e.g., grayscale voltages of grayscale levels 0 to 255) by dividing the gamma reference voltage from the master gamma circuit 910, the second slave gamma circuit 922 may generate a plurality of grayscale voltages (e.g., grayscale voltages of grayscale levels 0 to 255) by dividing the gamma reference voltage from the master gamma circuit 910, the third slave gamma circuit 923 may generate a plurality of grayscale voltages (e.g., grayscale voltages of grayscale levels 0 to 255) by dividing the gamma reference voltage from the master gamma circuit 910, the fourth slave gamma circuit 924 may generate a plurality of grayscale voltages (e.g., grayscale voltages of grayscale levels 0 to 255) by dividing the gamma reference voltage from the master gamma circuit 910, the fifth slave gamma circuit 925 may generate a plurality of grayscale voltages (e.g., grayscale voltages of grayscale levels 0 to 255) by dividing the gamma reference voltage from the master gamma circuit 910, and the sixth slave gamma circuit 926 may generate a plurality of grayscale voltages (e.g., grayscale voltages of grayscale levels 0 to 255) by dividing the gamma reference voltage from the master gamma circuit 910.

The first slave gamma circuit 921, the second slave gamma circuit 922, and the third slave gamma circuit 923 may be connected to the master gamma circuit 910 and the first data output circuit 812. The grayscale voltages from the first slave gamma circuit 921, the grayscale voltages from the second slave gamma circuit 922, and the grayscale voltages from the third slave gamma circuit 923 may be supplied to the first data output circuit 812. The first data output circuit 812 may output the first analog image signals based on the grayscale voltages from the first to third slave gamma circuits 921, 922, and 923.

The first slave gamma circuit 921 may be located in a non-display area NDA between the first data processing circuit 811 and the first data output circuit 812. A length of the first slave gamma circuit 921 (e.g., a size of the first slave gamma circuit 921 in the second direction DR2) may be smaller than a length of the second slave gamma circuit 922 (e.g., a size of the second slave gamma circuit 922 in the second direction DR2). A width of the first slave gamma circuit 921 (e.g., a size of the first slave gamma circuit 921 in the first direction DR1) may be smaller than a width of the second slave gamma circuit 922 (e.g., a size of the second slave gamma circuit 922 in the first direction DR1).

The second slave gamma circuit 922 may be located in the non-display area NDA adjacent to one edge of the first data processing circuit 811. For example, the second slave gamma circuit 922 may be located in the non-display area NDA between one edge of the first data processing circuit 811 and the pad portion PDA.

The third slave gamma circuit 923 may be located in the non-display area NDA adjacent to the other edge of the first data processing circuit 811. For example, the third slave gamma circuit 923 may be located in the non-display area NDA between the other edge of the first data processing circuit 811 and the edge of the display panel 100. A length of the third slave gamma circuit 923 (e.g., a size of the third slave gamma circuit 923 in the second direction DR2) may be equal to the length of the second slave gamma circuit 922 (e.g., the size of the second slave gamma circuit 922 in the second direction DR2). A width of the third slave gamma circuit 923 (e.g., a size of the third slave gamma circuit 923 in the first direction DR1) may be equal to the width of the second slave gamma circuit 922 (e.g., the size of the second slave gamma circuit 922 in the first direction DR1).

An area of the first slave gamma circuit 921, an area of the second slave gamma circuit 922, and an area of the third slave gamma circuit 923 may be equal to each other.

The fourth slave gamma circuit 924, the fifth slave gamma circuit 925, and the sixth slave gamma circuit 926 may be connected to the master gamma circuit 910 and the second data output circuit 822. The grayscale voltages from the fourth slave gamma circuit 924, the grayscale voltages from the fifth slave gamma circuit 925, and the grayscale voltages from the sixth slave gamma circuit 926 may be supplied to the second data output circuit 822. The second data output circuit 822 may output the second analog image signals based on the grayscale voltages from the fourth to sixth slave gamma circuits 924, 925, and 926.

The fourth slave gamma circuit 924 may be located in a non-display area NDA between the second data processing circuit 821 and the second data output circuit 822. A length of the fourth slave gamma circuit 924 (e.g., a size of the fourth slave gamma circuit 924 in the second direction DR2) may be smaller than a length of the fifth slave gamma circuit 925 (e.g., a size of the fifth slave gamma circuit 925 in the second direction DR2). A width of the fourth slave gamma circuit 924 (e.g., a size of the fourth slave gamma circuit 924 in the first direction DR1) may be smaller than a width of the fifth slave gamma circuit 925 (e.g., a size of the fifth slave gamma circuit 925 in the first direction DR1).

The fifth slave gamma circuit 925 may be located in the non-display area NDA adjacent to one edge of the second data processing circuit 821. For example, the fifth slave gamma circuit 925 may be located in the non-display area NDA between one edge of the second data processing circuit 821 and the pad portion PDA.

The sixth slave gamma circuit 926 may be located in the non-display area NDA adjacent to the other edge of the second data processing circuit 821. For example, the sixth slave gamma circuit 926 may be located in the non-display area NDA between the other edge of the second data processing circuit 821 and the edge of the display panel 100. A length of the sixth slave gamma circuit 926 (e.g., a size of the sixth slave gamma circuit 926 in the second direction DR2) may be equal to the length of the fifth slave gamma circuit 925 (e.g., the size of the fifth slave gamma circuit 925 in the second direction DR2). A width of the sixth slave gamma circuit 926 (e.g., a size of the sixth slave gamma circuit 926 in the first direction DR1) may be equal to the width of the fifth slave gamma circuit 925 (e.g., the size of the fifth slave gamma circuit 925 in the first direction DR1).

An area of the fourth slave gamma circuit 924, an area of the fifth slave gamma circuit 925, and an area of the sixth slave gamma circuit 926 may be equal to each other.

According to some embodiments, the first data output circuit 812 may be located between the second slave gamma circuit 922 and the third slave gamma circuit 923 without being separated into a plurality of circuit blocks. In other words, the second slave gamma circuit 922 and the third slave gamma circuit 923 are not located between the circuit blocks of the first data output circuit 812, but are located adjacent to edges on both sides of the first data output circuit 812, respectively. Accordingly, the first data output circuit 812 and the first distribution circuit 710 may be arranged to directly face each other. Therefore, output terminals of the first data output circuit 812 and input terminals of the first distribution circuit 710 may be connected without separate fan-out lines. Accordingly, outputs from the first data output circuit 812 may be stably supplied to the first distribution circuit 710. In the same manner, outputs from the second data output circuit 822 may be stably supplied to the second distribution circuit 720.

In addition, according to some embodiments, because the second slave gamma circuit 922 and the third slave gamma circuit 923 are not located between the circuit blocks of the first data output circuit 812, but are located adjacent to the edges on both sides of the first data output circuit 812, respectively, as described above, a length of the first data output circuit 812 in a direction (e.g., the second direction) toward the first data output circuit 812 in the display area DAA may be relatively reduced. For example, instead of increasing the width of the first data output circuit 812 (e.g., the size of the first data output circuit 812 in the first direction), the length of the first data output circuit 812 may be relatively reduced. Accordingly, the length of the first data output circuit 812 may be relatively reduced while maintaining an area of the first data output circuit 812. Therefore, an exposure may be possible in one shot during a photolithography process for forming the first data output circuit 812. In the same manner, an exposure may be possible in one shot during a photolithography process for forming the second data output circuit 822.

In addition, according to some embodiments, because one first slave gamma circuit 921 is located between the first data processing circuit 811 and the first data output circuit 812, an auxiliary circuit 503 may be further located in an area between the first data processing circuit 811 and the first data output circuit 812. For example, the auxiliary circuit 503 may include at least one of a regulator capable of generating various power sources required for driving the display panel 100, a decoupling circuit connected to driving lines connected to the sub-pixels SP1, SP2, and SP3 for noise reduction of the display panel 100, or a bias circuit for supplying power to the gamma circuit. In the same manner, an auxiliary circuit may be further located in an area between the second data processing circuit 821 and the second data output circuit 822.

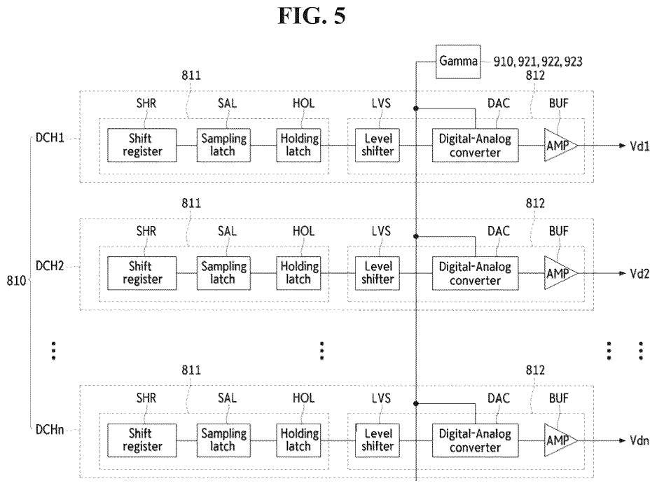

FIG. 5 is a detailed configuration diagram of a first data driving circuit of FIG. 4.

The first data driving circuit may include a plurality of channel circuits (e.g., data channel circuits) DCH1, DCH2, and DCHn, as illustrated in FIG. 5.

The plurality of channel circuits DCH1, DCH2, and DCHn may output a plurality of data voltages Vd1, Vd2, and Vdn. For example, a first channel circuit DCH1 may output a first data voltage Vd1, a second channel circuit DCH2 may output a second data voltage Vd2, and an n-th channel circuit DCHn may output an n-th data voltage Vdn. Here, n may be a natural number greater than 2.

The plurality of channel circuits DCH1, DCH2, and DCHn may be time-divisionally connected to the plurality of first data lines through the first distribution circuit 710. For example, the first data voltage Vd1 from the first channel circuit DCH1, the second data voltage Vd2 from the second channel circuit DCH2, and the n-th data voltage Vdn from the n-th channel circuit DCHn may be provided to the first distribution circuit.

Each of the channel circuits DCH1, DCH2, and DCHn may include the first data processing circuit 811 and the first data output circuit 812 described above.

The first data processing circuit 811 may include a shift register SHR (e.g., a data shift register), a sampling latch SAL (e.g., a data sampling latch), and a holding latch HOL (e.g., a data holding latch).

The first data output circuit 812 may include a level shifter LVS (e.g., a data level shifter), a digital-to-analog converter DAC (e.g., a data digital-to-analog converter), and a buffer BUF (e.g., a data buffer). Here, the buffer BUF may be connected to the first data line through the first distribution circuit 710.

The shift register SHR may receive a source shift clock and a source start pulse from the timing control circuit 400, and may sequentially generate a plurality of sampling signals by shifting the source start pulse every cycle of the source shift clock.

The sampling latch SAL may sequentially store a plurality of first digital image data signals in response to the plurality of sampling signals sequentially supplied from the shift register SHR.

The holding latch HOL may receive and store the first digital image data signal from the sampling latch SAL in response to a source output control signal (Source Output Enable), and output a sampled first digital image data signal that was stored in a previous period. The first digital image data signal output from the holding latch HOL may be provided to the digital-to-analog converter DAC through the level shifter LVS.

The level shifter LVS may convert a level of the first digital image data signal from the holding latch HOL and provide the converted level to the digital-to-analog converter DAC. For example, the level shifter LVS may convert the level of the first digital image data signal so that the first digital image data signal has a level that may drive transistors of the digital-to-analog converter DAC.

The digital-to-analog converter DAC may provide a first analog image signal corresponding to a bit value of the first digital image data signal supplied from the holding latch HOL through the level shifter LVS. For example, the digital-to-analog converter DAC may select a grayscale voltage corresponding to a bit value of the first digital image data signal from the holding latch HOL from at least one of the master gamma circuit 910, the first slave gamma circuit 921, the second slave gamma circuit 922, and the third slave gamma circuit 923, or output the selected grayscale voltage as a first analog image signal.

For example, the digital-to-analog converter DAC of the first channel circuit DCH1 among the plurality of channel circuits DCH1, DCH2, and DCHn of the first data driving circuit 810 may output a first analog image signal based on the grayscale voltages from the master gamma circuit 910, the digital-to-analog converter DAC of the second channel circuit DCH2 among the plurality of channel circuits DCH1, DCH2, and DCHn of the first data driving circuit 810 may output a first analog image signal based on the grayscale voltages from the first slave gamma circuit 921, the digital-to-analog converter DAC of the third channel circuit DCH3 among the plurality of channel circuits DCH1, DCH2, and DCHn of the first data driving circuit 810 may output a first analog image signal based on the grayscale voltages from the second slave gamma circuit 922, and the digital-to-analog converter DAC of the fourth channel circuit DCH4 among the plurality of channel circuits DCH1, DCH2, and DCHn of the first data driving circuit 810 may output a first analog image signal based on the grayscale voltages from the third slave gamma circuit 923.

The buffer BUF may receive a grayscale voltage (e.g., an analog image signal) from the digital-to-analog converter DAC, and amplify and output the grayscale voltage. For example, the buffer BUF may amplify the grayscale voltage and output a data voltage. The data voltage from the buffer BUF may be provided to the first data line DL through the first distribution circuit 710. The buffer BUF may include an amplifier.

The second data driving circuit 820 may have the same configuration as the first data driving circuit 810 described above. For example, as illustrated in FIG. 5, the second data driving circuit 820 may include n channel circuits, a shift register provided in each channel circuit, a sampling latch provided in each channel circuit, a holding latch provided in each channel circuit, a level shifter provided in each channel circuit, a digital-to-analog converter provided in each channel circuit, and a buffer provided in each channel circuit. The descriptions of the shift register, the sampling latch, the holding latch, the level shifter, the digital-to-analog converter, and the buffer of the second data driving circuit refers to FIG. 5 described above and related descriptions.

In this case, the digital-to-analog converter of the second data driving circuit 820 may provide a second analog image signal corresponding to a bit value of a second digital image data signal supplied from the holding latch through the level shifter. For example, the digital-to-analog converter of the second data driving circuit 820 may select a grayscale voltage corresponding to a bit value of the second digital image data signal from the holding latch of the second data driving circuit 820 from at least one of the master gamma circuit 910, the fourth slave gamma circuit 924, the fifth slave gamma circuit 925, or the sixth slave gamma circuit 926, and output the selected grayscale voltage as a second analog image signal.

For example, the digital-to-analog converter of the first channel circuit among the plurality of channel circuits of the second data driving circuit 820 may output a second analog image signal based on the grayscale voltages from the master gamma circuit 910, the digital-to-analog converter of the second channel circuit among the plurality of channel circuits of the second data driving circuit 820 may output a second analog image signal based on the grayscale voltages from the fourth slave gamma circuit 924, the digital-to-analog converter of the third channel circuit among the plurality of channel circuits of the second data driving circuit 820 may output a second analog image signal based on the grayscale voltages from the fifth slave gamma circuit 925, and the digital-to-analog converter of the fourth channel circuit among the plurality of channel circuits of the second data driving circuit 820 may output a second analog image signal based on the grayscale voltages from the sixth slave gamma circuit 926.

The display device 10 according to some embodiments may be applied to various electronic devices. An electronic device according to some embodiments may include the display device 10 described above, and may further include a module or device having additional functions in addition to the display device 10.

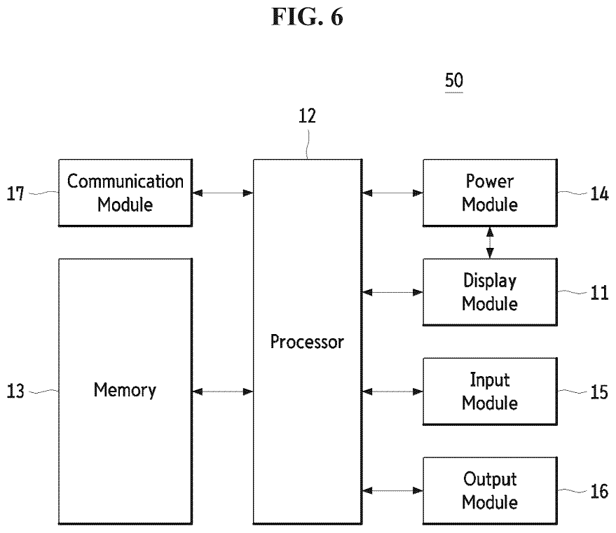

FIG. 6 is a block diagram of an electronic device according to some embodiments.

Referring to FIG. 6, an electronic device 50 according to some embodiments may include a display module 11, a processor 12, a memory 13, and a power module 14. The electronic device 50 may further include an input module 15, a non-image output module 16, and/or a communication module 17.

The electronic device 50 may output various information in the form of an image through the display module 11. When the processor 12 executes an application stored in the memory 13, image information provided by the application may be provided to the user through the display module 11. The power module 14 may include a power supply module, such as a power adapter or a battery device, and a power conversion module that converts power supplied by the power supply module to generate power required for an operation of the electronic device 50. The input module 15 may provide input information to the processor 12 and/or the display module 11. The non-image output module 16 may serve to receive information other than the image received from the processor 12, such as sound, haptics, and light emission, and provide the information to the user. The communication module 17 is a module responsible for transmitting and receiving information between the electronic device 50 and an external device, and may include a receiving unit and a transmitting unit.

At least one of the components of the electronic device 50 described above may be included in the display device according to the above-described embodiments. In addition, some of the individual modules functionally included within one module may be included within the display device, while others may be provided separately from the display device. For example, the display device includes the display module 11, and the processor 12, the memory 13, and the power module 14 may be provided in the form of other devices within the electronic device 50 other than the display device.

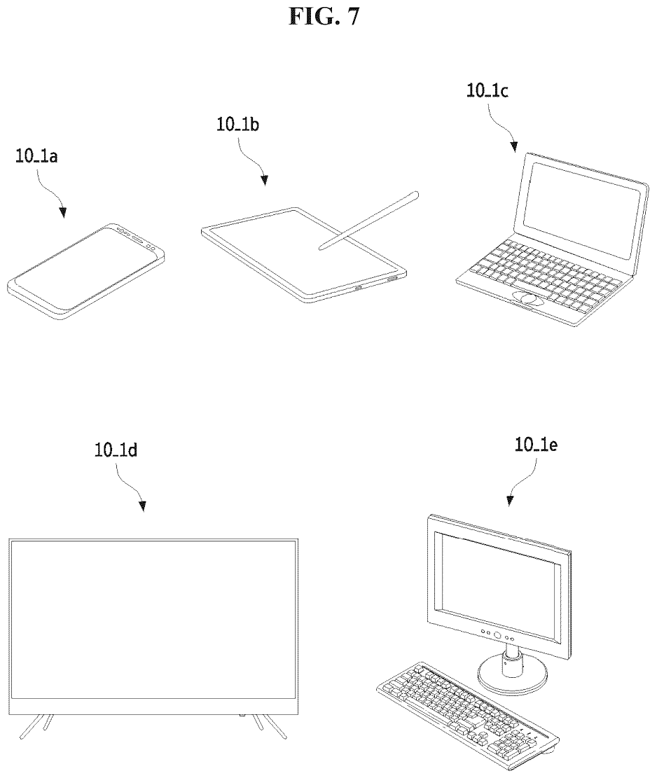

FIGS. 7, 8, and 9 are schematic diagrams of electronic devices according to various embodiments. FIGS. 7 to 9 illustrate examples of various electronic devices to which the display device 10 according to the embodiments is applied.

FIG. 7 illustrates examples of the electronic devices, including a smartphone 10_1a, a tablet PC 10_1b, a laptop 10_1c, a TV 10_1d, and a desk monitor 10_1e.

The smartphone 10_1a may include an input module such as a touch sensor and a communication module in addition to the display module 11. The smartphone 10_1a may process information received through the communication module or other input modules and display the information through the display module of the display device.

The tablet PC 10_1b, the laptop 10_1c, the TV 10_1d, and the desk monitor 10_1e also include a display module and an input module similarly to the smartphone 10_1a, and in some cases, may further include a communication module.

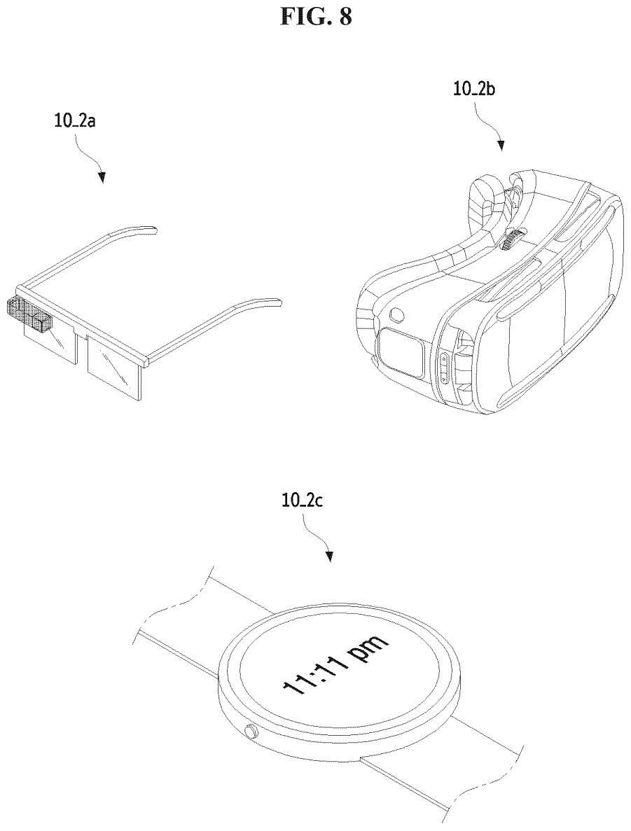

FIG. 8 illustrates a case in which an electronic device including a display module is applied to a wearable electronic device. The wearable electronic device may be a smart glasses 10_2a, a head mounted display 10_2b, a smart watch 10_2c, etc.

The smart glasses 10_2a and the head mounted display 10_2b may include a display module that emits a display image and a reflector that reflects the emitted display image and provides the reflected display images to the user's eyes, and may provide the user with a virtual reality or augmented reality screen through the display module and the reflector.

The smart watch 10_2c includes a biometric sensor as an input device and may provide the biometric information recognized by the biometric sensor to the user through the display module.

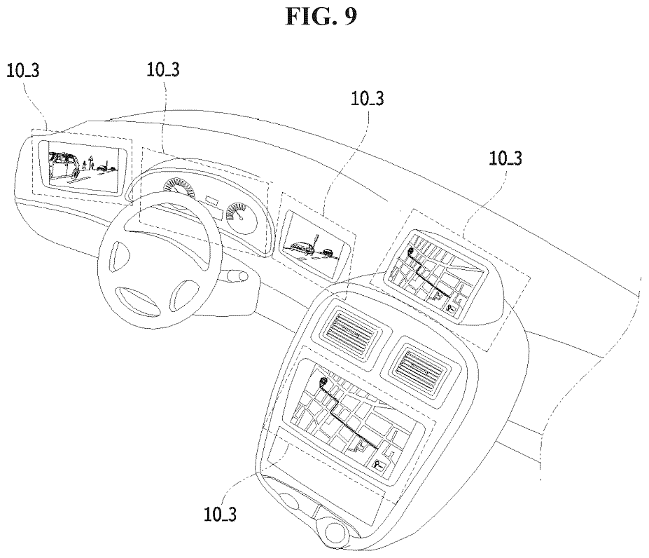

FIG. 9 illustrates an example in which an electronic device including a display module is applied to a vehicle. For example, an electronic device 10_3 may be applied to a dashboard, center fascia, etc. of an automobile, or may be applied to a Center Information Display (CID) located on the dashboard of the automobile or a room mirror display replacing a side mirror.

In concluding the detailed description, those skilled in the art will appreciate that many variations and modifications can be made to the disclosed embodiments without substantially departing from the spirit and scope of embodiments according to the present disclosure. Therefore, the disclosed embodiments of the invention are used in a generic and descriptive sense only and not for purposes of limitation.

What is claimed is:

1. A display device comprising:
a display panel including a display area and a non-display area;
a first data driving circuit in the non-display area on one side of the display area;
a first distribution circuit in the non-display area between the first data driving circuit and the display area; and
a gamma circuit configured to generate a plurality of grayscale voltages,
wherein the first data driving circuit includes a first data processing circuit configured to process first digital image data, and a first data output circuit configured to convert the first digital image data from the first data processing circuit into a first analog image signal based on the plurality of grayscale voltages from the gamma circuit and to provide the converted first analog image signal to the first distribution circuit,
the first data output circuit is in the non-display area between the first data processing circuit and the first distribution circuit,
the gamma circuit includes a master gamma circuit configured to generate a gamma reference voltage based on a reference voltage and to generate a plurality of grayscale voltages by dividing the gamma reference voltage, and a first slave gamma circuit configured to generate a plurality of grayscale voltages by dividing the gamma reference voltage from the master gamma circuit, and
the first slave gamma circuit is in the non-display area between the first data processing circuit and the first data output circuit.

2. The display device of claim 1, wherein the gamma circuit further includes a second slave gamma circuit and a third slave gamma circuit configured to generate a plurality of grayscale voltages by dividing the gamma reference voltage from the master gamma circuit.

3. The display device of claim 2, wherein the second slave gamma circuit is in the non-display area adjacent to one edge of the first data output circuit.

4. The display device of claim 3, wherein the third slave gamma circuit is in the non-display area adjacent to the other edge of the first data output circuit.

5. The display device of claim 4, wherein the first data output circuit is in the non-display area between the second slave gamma circuit and the third slave gamma circuit.

6. The display device of claim 5, wherein a length of the first slave gamma circuit is smaller than a length of the second slave gamma circuit, and
a width of the first slave gamma circuit is greater than a width of the second slave gamma circuit.

7. The display device of claim 6, wherein an area of the first slave gamma circuit, an area of the second slave gamma circuit, and an area of the third slave gamma circuit are equal to each other.

8. The display device of claim 5, further comprising an auxiliary circuit in the non-display area between the first data processing circuit and the first data output circuit.

9. The display device of claim 1, further comprising:
a second data driving circuit in the non-display area on the other side of the display area; and
a second distribution circuit in the non-display area between the second data driving circuit and the display area.

10. The display device of claim 9, wherein the second data driving circuit includes:
a second data processing circuit configured to process second digital image data; and
a second data output circuit configured to convert the second digital image data from the second data processing circuit into a second analog image signal based on the plurality of grayscale voltages from the gamma circuit and to provide the converted second analog image signal to the second distribution circuit.

11. The display device of claim 10, wherein the second data output circuit is in the non-display area between the second data processing circuit and the second distribution circuit.

12. The display device of claim 11, wherein the gamma circuit further includes a fourth slave gamma circuit configured to generate a plurality of grayscale voltages by dividing the gamma reference voltage from the master gamma circuit.

13. The display device of claim 12, wherein the fourth slave gamma circuit is in the non-display area between the second data processing circuit and the second data output circuit.

14. The display device of claim 13, wherein the gamma circuit further includes a fifth slave gamma circuit and a sixth slave gamma circuit configured to generate a plurality of grayscale voltages by dividing the gamma reference voltage from the master gamma circuit.

15. The display device of claim 14, wherein the fifth slave gamma circuit is in the non-display area adjacent to one edge of the second data output circuit.

16. The display device of claim 15, wherein the sixth slave gamma circuit is in the non-display area adjacent to the other edge of the second data output circuit.

17. The display device of claim 16, wherein the second data output circuit is in the non-display area between the fifth slave gamma circuit and the sixth slave gamma circuit.

18. The display device of claim 17, wherein a length of the fourth slave gamma circuit is smaller than a length of the fifth slave gamma circuit, and
a width of the fourth slave gamma circuit is greater than a width of the fifth slave gamma circuit.

19. An electronic device comprising:
a display device including a screen,
wherein the display device includes:
a display panel including a display area and a non-display area;
a first data driving circuit in the non-display area on one side of the display area;
a first distribution circuit in the non-display area between the first data driving circuit and the display area; and
a gamma circuit configured to generate a plurality of grayscale voltages,
the first data driving circuit includes a first data processing circuit configured to process first digital image data, and a first data output circuit configured to convert the first digital image data from the first data processing circuit into a first analog image signal based on the plurality of grayscale voltages from the gamma circuit and to provide the converted first analog image signal to the first distribution circuit,
the first data output circuit is in the non-display area between the first data processing circuit and the first distribution circuit,
the gamma circuit includes a master gamma circuit configured to generate a gamma reference voltage based on a reference voltage and to generate a plurality of grayscale voltages by dividing the gamma reference voltage, and a first slave gamma circuit configured to generate a plurality of grayscale voltages by dividing the gamma reference voltage from the master gamma circuit, and
the first slave gamma circuit is in the non-display area between the first data processing circuit and the first data output circuit.

20. The electronic device of claim 19, wherein the electronic device is one of a smartphone, a tablet, a laptop, a TV, a desk monitor, a smart glasses, a smart watch, a head mounted display, or a vehicle.
